(19) United States
(12) Patent Application Publication
(10) Pub. No.: US 2006/0278057 A1
(43) Pub. Date: Dec. 14, 2006

(54) Rotary wire cutter

(76) Inventor: Kim Wuertemberger, Richmond, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/152,797

(22) Filed: Jun. 14, 2005

(51) Int. Cl. B26D 1/46; B27B 13/00

(52) U.S. Cl. 83/651.1; 83/661; 83/809

(57) ABSTRACT

A continuous wire cutter for cutting and shaping products, particularly foam products. A frame supports a work piece movable along an x axis. A cutting head is movable along a y axis to and from the work piece. The head contains a continuous wire that drivingly engages and cuts the work piece. The c-shaped arm may be pivoted both about the y axis, the x axis and the z axis.

### BACKGROUND OF THE INVENTION

The present invention relates generally to the field of devices using a wire for cutting a work piece.

### DESCRIPTION OF THE PRIOR ART

Vertical band saws are used to cut a variety of materials including work pieces made of wood. The band saw includes a continuous ribbon having a serrated edge forming a plurality of teeth with the saw moved by a series of drive wheels. Different types of band saws are shown in the U.S. Pat. No. 3,474,693 issued to Wilkie et al., U.S. Pat. No. 4,658,689 issued to Yakich, U.S. Pat. No. 5,203,247 issued to D'Arcy, and U.S. Pat. No. 5,878,644 issued to Jasinski.

Due to the shape and configuration of the end product, there are provided band saws that orient the cutting edge at different angles with respect to the work piece. For example, in U.S. Pat. No. 4,393,450 issued to Jerard there is disclosed a cutting wire acting in a reciprocating mode that is movable with respect to the work piece in an X and Y axis and also a rotational axis. In the U.S. Pat. No. 6,267,037 issued to McCoy, Jr. et al., there is shown a cutting device for cutting a pipeline with the cutting structure rotatable about a longitudinal axis. A different approach is shown in U.S. Pat. No. 4,909,108 issued to Nakada et al. wherein a processing tool is movable by tilting an endless cutter depending upon the angle of inclination of a curved plate work piece.

Wire cutters are particularly useful when cutting relative soft material, such as solid foam material. For example, in the U.S. Pat. No. 4,915,000 issued to MacFarlane there is disclosed a continuous cutting wire used to cut foam material. The versatility of the wire cutter may be increased by increasing the different planes in which the wire extends relative to the work piece.

Disclosed herein is a wire cutter for cutting a variety of material and particularly foam material. Normally, the continuous wire moves in a vertical direction along a z-axis with the wire moving relative to the work piece along a y-axis. Further, the cutter is operable to cause relative motion between the wire and the work piece in the x-axis. Adding to the versatility of the wire cutter is achieved by allowing the wire to pivot about the x-axis and also about the y-axis allowing the wire to cut and shape the work piece in a superior manner as compared to the prior art cutters that are limited in movement.

### SUMMARY OF THE INVENTION

One embodiment of the present invention is a rotary wire apparatus for cutting a work piece that comprises a frame for supporting a work piece along an x axis. A wire cutter extends along a z axis and is movable against the work piece along the z axis to cut same. The wire further has a y axis of movement. A first driver is associated with the wire to move the wire against the work piece along the z axis. A second driver is associated with the wire to move the wire against the work piece along the y axis. A third driver is associated with the wire to pivot the wire against the work piece about the x axis. A fourth driver is associated with the wire to pivot the wire against the work piece about the y axis.

### BRIEF DESCRIPTION OF THE DRAWINGS

FIG. 1 is a perspective view of the rotary wire apparatus incorporating the present invention.

FIG. 2 is an enlarged cross sectional view taken along the line 2-2 of FIG. 1 and viewed in the direction of the arrows showing the cutting head and associated cutting wire.

FIGS. 3 and 4 are the same view as FIG. 2 only showing the cutting head and wire after it has been pivoted about the x axis.

FIG. 5 is a perspective top view of the cutting head and wire after the wire has been pivoted about the y axis.

FIG. 6 is a top view of the cutting head and wire shown in FIG. 5.

### DESCRIPTION OF THE PREFERRED EMBODIMENT

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

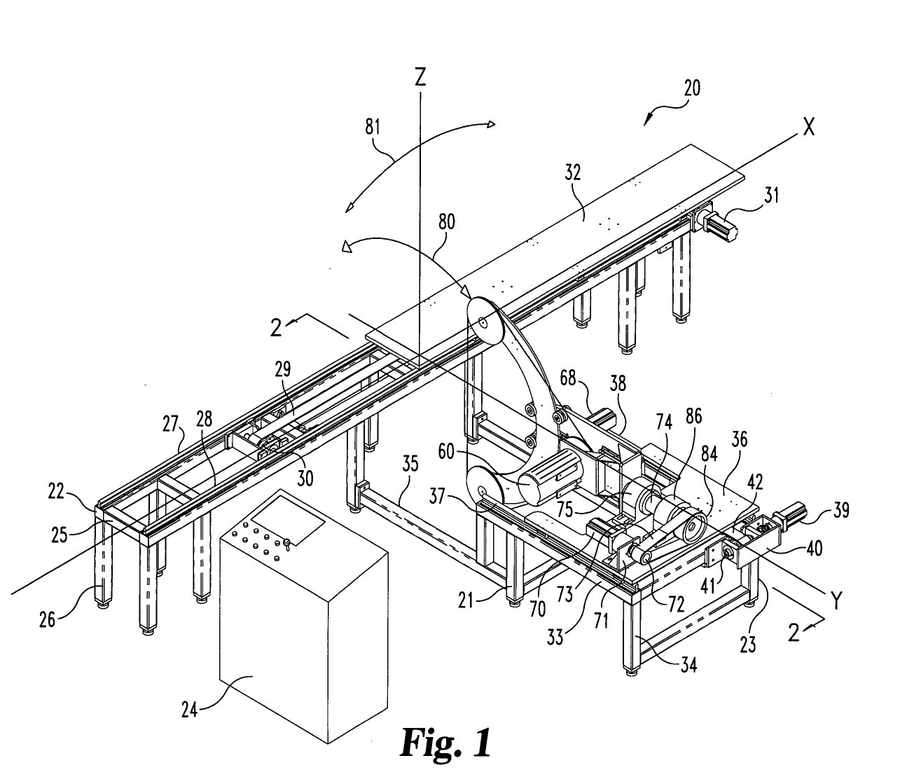

Referring now more particularly to FIG. 1, there is shown a rotary wire apparatus 20 for cutting a work piece. The apparatus includes a frame 21 comprising a sub-frame 22 for supporting the work piece and a second sub frame 23 for supporting the cutting apparatus. A controller 24 including conventional programming capability is provided to control the movement of the work piece and cutting head and wire.

Sub-frame 22 has a rectangular upper frame 25 supported on a plurality of legs 26. A pair of parallel and spaced apart rails 27 and 28 are fixedly mounted atop rectangular upper frame 25. A continuous belt 29 extends around a roller 30 rotatably mounted to the upper frame 25 with the opposite end of the belt extending around a drive roller fixedly mounted to the output shaft of motor 31 mounted to the sub-frame 22. Operation of motor 31 results in rotation of its output shaft and, in turn, rotation of the output drive roller mounted thereon that is frictionally engaged with continuous belt 29 thereby causing movement of belt 29 along the x axis. A work piece supporting panel 32 having a flat upper surface rests atop rails 27 and 28 and has a bottom or downwardly facing surface engaged with belt 29. Thus, activation of motor 31 results in belt 29 moving along the direction of the x axis and carrying in the same direction panel 32 and the work piece resting there atop. To ensure consistent movement of panel 32, the panel may be fixedly attached to belt 29 to move therewith as a unit. Alternatively, the panel may be frictionally engaged by the belt.

Sub-frame 23 is attached to sub-frame 22 by means of cross members 35 fixedly attached to the downwardly extending legs 34 of sub-frame 23 and the downwardly extending legs 26 of sub-frame 22. A rectangular frame 33 is fixedly mounted atop legs 34 and has a pair of parallel and spaced apart rails 37 and 38 mounted thereon and extending in the direction of the y axis. A platform 36 rests atop rails 37 and 38 and is driven along the y axis by motor 39. The motor is mounted to frame 33 by bracket 40 and has a rotatable output shaft 41 frictionally engaged with a continuous belt 42 either attached to the bottom of platform 36 or frictionally engaging the bottom surface of the platform so as to move the platform to and from the work piece along the y axis. Mounted atop platform 36 are motors along with the cutting head for controlling movement of the cutting wire.

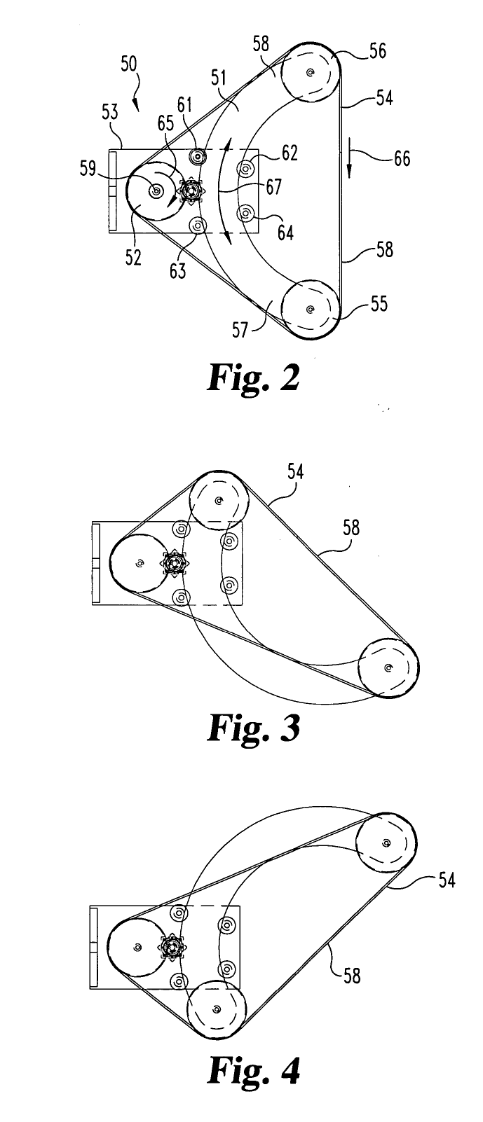

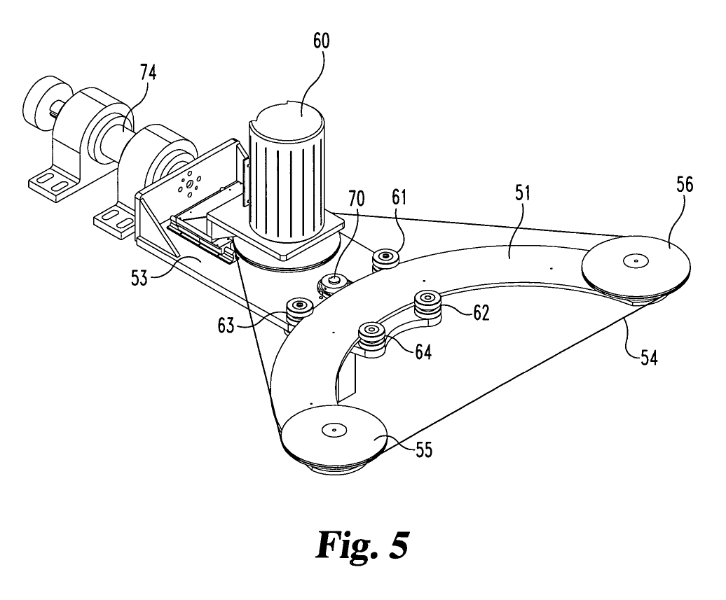

Cutting head 50 (FIG. 2) includes a c-shaped arm 51 slidably mounted to bracket 53, in turn, mounted atop platform 36. A continuous cutting wire 54 extends around a pair of rollers 55 and 56, in turn, rotatably mounted to the opposite ends 57 and 58 of the c-shaped arm. Further, wire 54 extends around drive roller 52 fixedly mounted to the rotatable output shaft 59 of motor 60 (FIG. 1). The portion 58 of wire 54 extending across the open side of c-shaped arm 51 between rollers 55 and 56 is used for directly engaging and cutting the work piece resting atop platform 32.

Wheels 61-64 are rotatably mounted to bracket 53 with each wheel having a continuous groove to engage and support the opposite extending edges of c-shaped arm 51. Wheels 61 and 63 are located on one side of arm 51, whereas the remaining two wheels 62 and 64 engage the opposite side edge of the arm. Activation of motor 60 causes its output shaft and attached drive wheel 52 to rotate thereby causing movement of wire 54. For example, with wheel 52 rotating in the clockwise direction 65 as illustrated in FIG. 2, wire 54 is caused to move in the direction of arrow 66 between rollers 56 and 55. With the arm 51 extending in the vertical or z direction, wire 66 may also be moved in the z direction as shown by arrow 66 thereby engaging the work piece.

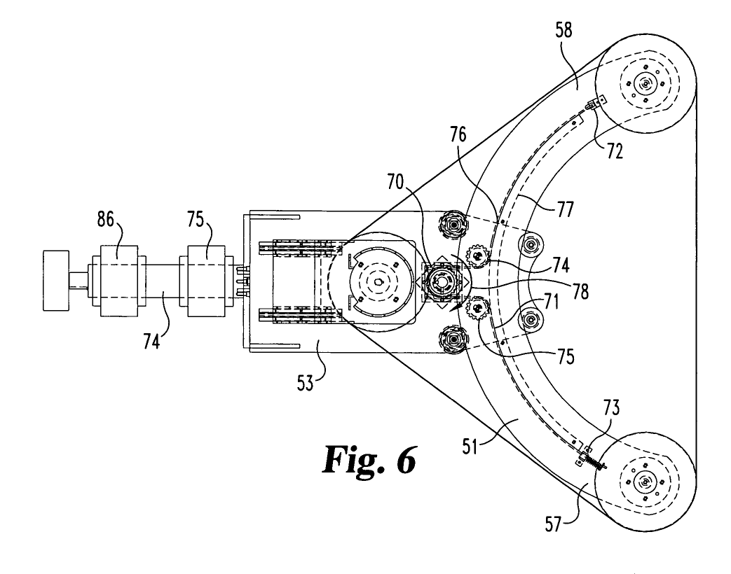

Movement of arm 51 in either opposite direction of arrow 67 (FIG. 2) is controlled by motor 68 (FIG. 1) fixedly mounted to bracket 53. The output shaft of motor 68 includes a gear 70 (FIG. 6) fixedly mounted thereon that is in meshing engagement with chain 76 having opposite ends attached by brackets 72 and 73 to the opposite ends 58 and 57 of the c-shaped arm. A pair of spaced apart bearings 74 and 75 are mounted to arm 51 to guide chain 76 from gear 70 to ends 57 and 58. Further, a guide wall 77 is mounted to the arm to guide the chain along the curve of the arm. Thus, by activating motor 68, relative motion between arm 51 and bracket 53 may be controlled. For example, activation of motor 68 causing gear 70 to rotate in a clockwise direction 78 (FIG. 6) will cause the c-shaped arm to move from the position depicted in FIG. 2 to the position illustrated in FIG. 4. Rotation of gear 70 in a counterclockwise direction will cause the c-shaped arm to move to the position illustrated in FIG. 3. Thus, with the arm extending in the z direction, as illustrated in FIG. 1, activation of motor 68 will cause portion 58 of wire 54 to pivot about the x axis in the direction of arrow 80 to the various positions illustrated in FIGS. 2-4 thereby allowing the wire to cuttingly engage the work piece in a variety of positions.

Pivotal movement of wire 54 about the y axis is controlled by motor 70 fixedly mounted to bracket 71 (FIG. 1), in turn, mounted atop platform 36. Motor 70 has a rotatable output shaft 72 engaged with a continuous belt 73, in turn, engaged with wheel 84 fixedly mounted to axle 74 rotatably mounted in bearings 75 and 86 mounted atop platform 36. Axle 74 extends through the bearings and is fixedly attached to bracket 53. Bracket 53 is mounted atop platform 36 by means of axle 74 and thus is free to rotate about the y axis along with axle 74. By activating motor 70, the output shaft 72 is cause to rotate causing movement of continuous belt 73 and rotation of axle 74 and thus rotation of bracket 53 along the y axis. Rotation of bracket 53 causes the c-shaped arm 51 to also rotate about the y axis thereby allowing portion 58 of wire 54 to rotate about the y axis in the direction of arrow 81 (FIG. 1) engaging the work piece atop the platform in a variety of different positions.

Motor 68 causes arm 51 to pivot or move about the x axis while remaining in a single plane. With the c-shaped arm extending in the vertical direction as shown in FIG. 1, the arm may be pivoted or moved to the various positions of FIGS. 2-4 within a plane that is perpendicular to a horizontal plane containing the x axis. By activating motor 70 to cause rotation of axle 74, the c-shaped arm may be positioned in a number of different planes intersecting a horizontal plane at various angles.

With the c-shaped head initially extending vertically as depicted in FIG. 1, the head may then be pivoted or moved about both the x axis and the y axis. When the head is pivoted or moved about the y axis so wire 54 extends along the x axis, the c-shaped arm may then be pivoted or moved about the z axis. In other words, depending upon the particular position of the c-shaped arm 51, the arm and associated wire may be pivoted or moved about the x axis, the y axis and also the z axis.

The first driver or motor 31 is operable to cause relative motion along the x axis between the work piece and wire 54. The second driver or motor 60 moves the wire against the work piece along the z axis whereas the third driver or motor 39 moves the wire against the work piece along the y axis. The fourth driver or motor 70 pivots or moves the wire relative to the work piece about the y axis. The fifth driver or motor 68 pivots the wire relative to the work piece about the x axis when the c-shaped arm extends vertically. Further, the fifth driver or motor 68 pivots the wire relative to the work piece about the z axis when the head extends horizontally or the wire extends in the direction of the x axis.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A rotary wire apparatus for cutting a work piece comprising:
a frame for supporting a work piece along an x axis;
a wire extending along a z axis perpendicular to said x axis and movable against said work piece along said z axis to cut same, said wire further having a y axis of movement perpendicular to said x axis;
a first driver associated with said wire to move said wire against said work piece along said z axis;
a second driver associated with said wire to move said wire against said work piece along said y axis;
a third driver associated with said wire to pivot said wire against said work piece about said x axis; and,
a fourth driver associated with said wire to pivot said wire against said work piece about said y axis.

2. The apparatus of claim 1 and further comprising:
a fifth driver engageable with said work piece to move said work piece on said frame along said x axis.

3. The apparatus of claim 2 and further comprising:
a head pivotally mounted on said frame to pivot both around said y axis and said x axis.

4. The apparatus of claim 3 wherein:
said head has a C shaped arm with a first end and an opposite end and includes a plurality of bearings mounted thereto, said wire is continuous extending around and guided by said bearings with said wire extending between said first end and said second end forming a cutting wire portion engageable with said work piece.

5. The apparatus of claim 4 wherein:
said bearings include a first pair of wheels and a second pair of wheels rotatably mounted with said arm extending between and guided by said first pair and said second pair, said third driver includes a motor engaged with said arm to pivot said arm about said x axis, said first driver includes a motor engaged with said wire to move said wire along said z axis, said fourth driver includes a motor engaged with said arm to pivot said arm about said y axis.

6. The apparatus of claim 2 wherein:
said fifth driver includes a motor and a belt engaged together with said belt engageable with said work piece to move said work piece along said x axis past said wire.

7. The apparatus of claim 1 and further comprising:
a platform movably mounted atop said frame and having said wire, said first driver, said third driver and said fourth driver mounted thereatop with said second driver engaged between said platform and said frame to move said platform along said y axis.

8. A rotary wire apparatus for cutting a work piece comprising:
a frame including a work piece support portion extending along an x axis for supporting a work piece;
a wire extending along a z axis perpendicular to said x axis and contactable against said work piece along said z axis to cut same;
a first driver associated with said wire to move said wire along said z axis to cut said work piece;
a second driver to cause relative motion between said wire and said work piece portion along a y axis perpendicular to said x axis and said z axis to contact said wire with the work piece positioned on said work piece portion;
a third driver associated with said wire to cause pivotal motion between said wire and said work piece portion about said x axis; and,
a fourth driver associated with said wire to cause pivotal motion between said wire and said work piece portion about said y axis.

9. The apparatus of claim 8 and further comprising:
a head pivotally mounted on said frame to pivot around said y axis, said x axis and said y axis, said head has a C shaped arm with a first end and an opposite second end and includes a plurality of bearings mounted thereto, said wire is continuous extending adjacent and guided by said bearings with said wire extending between said first end and said second end forming a cutting wire portion engageable with said work piece.

10. The apparatus of claim 9 wherein:
said bearings include a first pair of wheels and a second pair of wheels rotatably mounted with said arm extending between and supported by said first pair and said second pair, said third driver includes a motor engaged with said arm to move said arm about said x axis and about said z axis, said first driver includes a motor engaged with said wire to move said wire in said z axis, said fourth driver includes a motor engaged with said arm to pivot said arm about said y axis.

11. A rotary wire apparatus for cutting a work piece comprising:
frame means for supporting a work piece along a first axis;
a wire extending along a second axis and movable against said work piece along said second axis to cut same, said wire further having a third axis of movement;
a first driver to cause relative motion between said work piece and said wire along said first axis;
a second driver associated with said wire to move said wire against said work piece along said second axis;
a third driver associated with said wire to move said wire against said work piece along said third axis;
a fourth driver associated with said wire to pivot said wire relative to said work piece about said third axis; and,
a fifth driver associated with said wire to pivot said wire relative to said work piece about said first axis.

12. The apparatus of claim 11 wherein:
said fifth driver pivots said wire relative to said work piece about said second axis when said wire extends in the direction of said first axis.

13. The apparatus of claim 11 and further comprising:
a head having said wire movably mounted thereon, said head connected to said fourth driver and said fifth driver to pivot about said third axis and said first axis.

14. The apparatus of claim 12 and further comprising:
a platform slidably mounted atop said frame means with said first driver engaged between said platform and said frame means to move said head and wire to and from said work piece.
